(19) United States
(12) Patent Application Publication
(10) Pub. No.: US 2026/0154660 A1
(43) Pub. Date: Jun. 4, 2026

(54) Digital Time Capsule for Sending Future Video, Voice, Images and Text Messages

(71) Applicant: Maria R. Sullivan, Windham, NH (US)

(72) Inventor: Maria R. Sullivan, Windham, NH (US)

(21) Appl. No.: 18/636,420

(22) Filed: Apr. 16, 2024

Related U.S. Application Data
(60) Provisional application No. 63/456,893, filed on Apr. 4, 2023.

(51) Int. Cl. G06Q 10/109; G06Q 50/00; H04W 4/12

(52) U.S. Cl. CPC G06Q 10/109; H04W 4/12; G06Q 10/40

(57) ABSTRACT

The Digital Time Capsule application is used to send friends, family, or yourself, digital messages to be delivered in the future at any future date. The message can be a video, photo, image, audio, or text message and is delivered by the APP platform. The app is similar to a time capsule but digital in nature. The value of the app is the ability to capture a moment of someone's life at the present time and deliver it to friends, family, etc. on a future date or dates of special moments, such as birthdays, holidays, anniversaries, etc. The app also has a Social Section where you can share your future message with all users, when that future date arrives. There is no application today that allows you to do this.

### CROSS-REFERENCE TO RELATED APPLICATIONS

Provisional Patent No. 63/456,893

### FIELD

Application platform for sending future messages. In particular, creating a video, photo, audio, image, or text message and sending it to specific people (including yourself or the public) to be delivered at a future date.

### BACKGROUND OF THE INVENTION

Currently, all messaging platforms support immediate delivery of messages.

Therefore, when someone wants to send a text, photo, or video message, the sender creates the message, and it is sent and delivered immediately on a mobile app platform. In today's busy environment, we miss the opportunity to send messages on days of special occasions, such as Birthdays, Anniversaries, Graduation, etc. Also, no one is assured of their day of death and if they are, limited ways exist to assure that our last messages will be delivered to our family, friends, loved ones, etc. after death. If we want to remember and share special moments, we can look through our camera roll of memories, but there is no way to send current memories into the future. Life gives us special moments, achievements, and adventures, that we want to remember forever. The invention of this application allows users to send video, photos, text and audio messages to others or yourself to be delivered at any future date.

### SUMMARY OF THE INVENTION

A mobile app that allows you to create a message now and deliver it to friends, family, or yourself, at any future date. The message can be a video, photo, image, audio, or text message and is delivered by the APP platform. The app is similar to a time capsule but digital in nature. The user can create messages within the app by either uploading videos and photos from the device photo library or by using the device's native camera for taking “live” photos, videos or audio recordings and attaching them to the message. In addition, the user can add text to the message and use the device built in keyboards to write a personal note, then the user can select any future delivery date and send it to friends, family, etc. Once a message is being sent the app sends an SMS text message to users that have not yet downloaded the app (enabling them to download it via a direct link to the app store and google play store) or sends a pop-up notification for users that have the app downloaded on their mobile device. Users will receive several pop-up notifications reminding them that their message delivery due date is arriving soon, finally when the message is opened on the delivery date, the app will send a pop-up notification to the sender notifying him the message has been read by the receiver. The app also has a Social Section where you can share your future message with all users, when that future date arrives. To share your message publicly, you simply select the public check off box and when the future date arrives, the message will be sent to the specific person your message was intended for and will be shared in the Social Section of the app. There is no application today that allows you to do this.

### BRIEF DESCRIPTION OF THE DRAWINGS

FIG. 1 shows How to Log into the Mobile App

FIG. 2 shows the Apps Main Dashboard options which displays the Social, Messaging (Inbox & Sent), and Contacts Section

FIG. 3 shows the flow on How to Create and Send a Message

### DETAILED DESCRIPTION OF DRAWINGS

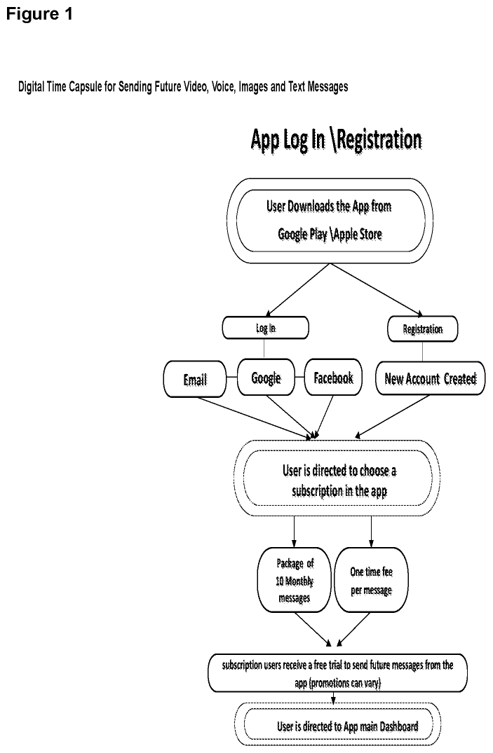

FIG. 1 shows the first steps a user performs to log in or register to the App. Once a user downloads the app, they will need to enter their mobile number, register by creating an account, or logging in using their Google or Facebook account or by using an email address. Then the user is directed to subscribe to the app and is directed to the app main dashboard.

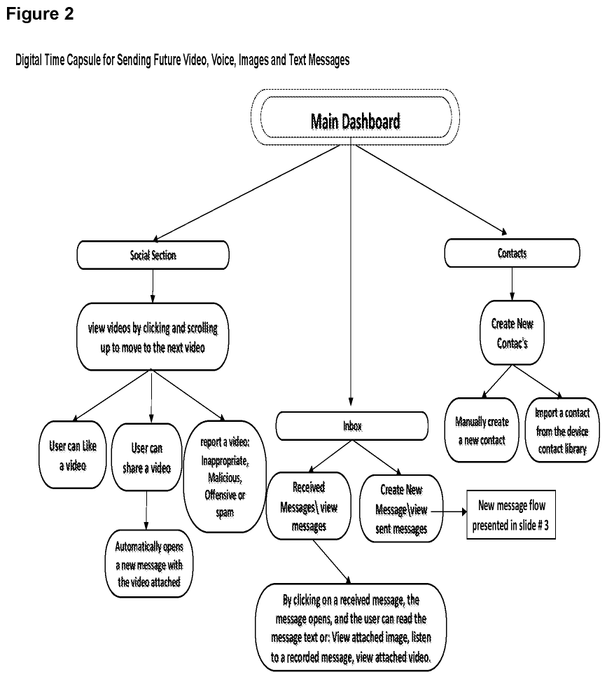

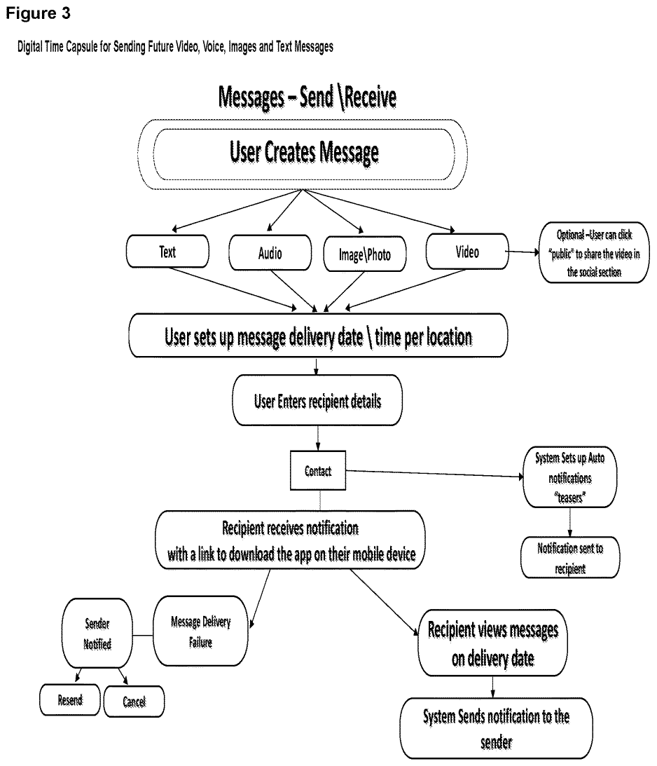

FIG. 2 shows the three main usages that the user can perform at the main dashboard. Option 1 is adding new contacts, Option 2 is the app's Social Section or Option 3 the app's Messages. When adding new contacts, the user can choose from importing them from the device's contact library or manually entering the new contact detail of first name, last name, and mobile number. The Social Section contains various video messages that the sender chose to share publicly in the Social Section. When a user enters this section, there are vrous videos to choose from by clicking the video and it will start playing in a full screen mode. Users can like the video, share the video within the apps messages section or report a video. Option 3 Messages, contains a sent and inbox section where you can review received messages or create new messages (see full description in FIG. 3).

FIG. 3 shows how to create and send future messages. Within the messages Inbox section, user creates or uploads a video, image, text, or audio message to send to a specific contact and also has an option to share their message publicly by checking the “public box”. The User then sets the delivery date and enters the recipient details by choosing a contact. Once a message is sent, the recipient receives a notification either by an SMS text message if the user does not have the app installed on their device or if they have the app installed on their device, the recipient will receive a pop-up notification informing them that they have a future message from the sender's first and last name. In addition, the app notifies the sender that their message has been sent and gives the sound of a chime. Up until the future delivery date arrives, the app will send a number of count-down pop-up notifications reminding the recipient that they have a future message that can be opened on the delivery date. Once the delivery date arrives, the recipient can view their message and the app will send a notification to the sender.

1. (canceled)

2. (canceled)

3. An application that enables users to create and send in app text, video, audio or image messages to friends, family, loved ones, self, or to the public for delivery of the message at any set future delivery date:
a. said application comprises a Sent Folder and Inbox Folder to view messages sent or received whereby showing message To/From information, Delivery Date, and contains a Social Section page;
b. said application comprises integration with the end user's mobile device contacts and enables the user to add contact details in order to migrate their contacts details to the app Contact library in order to send them a future date message;
c. said application comprises integration with the end user's mobile device photo and video library in order to attach photos or videos to a future date message;
d. the application integrates with the end user's mobile device keyboards in order to type text messages (and attach emoji's) to a future date message;
e. the application comprises integration with the end user's mobile device camera in order to take photos and record videos and attach them to a future date message;
f. said app comprises using the mobile device's built in microphone to record audio messages or record audio sounds while using the built in device camera for photo and video recording;
g. the Application stores all types of messages (video, photos, images, text, audio) and releases it for the recipient to view only on the selected future date, set by the sender;
h. the application comprises the sending of automatic notifications to recipient when a message has been sent to them and by whom and notifications at different timeframes to remind them of their upcoming future message delivery date;
i. the Application comprises a Social Section for future messages where all app users can view these future messages that have been sent and shared with the “public” on their future delivery date.

4. Application Procedure for Sending a Future Video, Voice, Photo, or Text Message:
a. said Application provides the ability to capture a moment of someone's life, via photo, video, or text, at the current or present time and deliver it to friends, family, etc. at a future date by selecting the future date on the calendar within the App;
b. said application comprises the ability to select a specific person to send your future message to;
c. said Application comprises a Social Section where users can choose to share their future message with the public on the future delivery date. The Social Section is viewable to all app users;
d. said application will comprise integration with social media platforms (such as Facebook, TikTok, Instagram, Snapchat, BeReal app, etc.) in order to share content and send them in a future message or in the app's social section;
e. said application provides an in-app notification that their future message has been sent and that their message has been viewed by the recipient;
f. said application provides a notification to the receiver that a message has been sent to them through the App and also sends them periodic pop-up notifications reminding them of their upcoming future message delivery due date;
g. said app comprises the ability for users to select their mobile device's built in microphone to record audio messages or record audio sounds while using their built in device camera for photo or video recording to send their message.
